(19) United States
(12) Patent Application Publication
(10) Pub. No.: US 2015/0276531 A1
(43) Pub. Date: Oct. 1, 2015

(54) PRESSURE SENSOR

(71) Applicant: TOYOTA JIDOSHA KABUSHIKI KAISHA, Toyota-shi (JP)

(72) Inventors: Yasushi MATSUHIRO, Kota-cho (JP); Masato NAKAJIMA, Susono-shi (JP)

(21) Appl. No.: 14/665,359

(22) Filed: Mar. 23, 2015

(30) Foreign Application Priority Data
Mar. 26, 2014 (JP) 2014-064666

(51) Int. Cl. G01L 9/00; G01D 5/241; G01L 9/12

(52) U.S. Cl. CPC G01L 9/0072; G01L 9/12; G01D 5/241

(57) ABSTRACT

Disclosed is a pressure sensor which can achieve both a larger capacitance change and miniaturization of a device than ever before. A pressure sensor comprises a layer constitution in which a dielectric layer is sandwiched by a pair of electrode layers and a pair of insulating substrates in order, and detects pressure based on a capacitance value between electrodes which is varied by a deflection amount of at least one of the dielectric layer and the pair of the electrode layers and, wherein, on each side of the pressure sensor, at least one of the electrode layer and the dielectric layer has concave and convex parts on the surface facing the other layer, and the electrode layer and the dielectric layer are in contact with each other through at least the convex parts of the concave and convex parts.

### TECHNICAL FIELD

The present invention relates to a pressure sensor which can achieve both a larger capacitance change and miniaturization of a device than ever before.

### BACKGROUND ART

In surface pressure sensors, which are one type of pressure sensors, various layer constitutions are employed. Patent literature 1 discloses a capacitance type force sensor for measuring pressure by obtaining a capacitance change accompanying pressure of a capacitor element in a pressure detection part, wherein the capacitor element is formed by layering a plurality of electrodes by interposing elastic dielectric in which elastics are changed by pressure between counter electrodes, and layering the electrodes in different number between one side of the electrode and the other side of the electrode.

### CITATION LIST

[Patent literature 1] Japanese Patent Application Laid-Open (JP-A) No. H7-55615

### SUMMARY OF INVENTION

### Technical Problem

The constitution using a plurality of dielectric layers as disclosed in Patent literature 1 is considered to have problems that cost is increased by complication of the constitution, and that the dimension change in a direction perpendicular to surface pressure differs between dielectric bodies, therefore a dielectric layer has warpage, which results in producing output fluctuation.

The present invention was made in view of the current situation which requires simpler constitution in pressure sensors, and it is an object of the present invention is to provide a pressure sensor which can achieve both a larger capacitance change and miniaturization of a device than ever before.

### Solution to Problem

The pressure sensor of the present invention comprises a layer constitution in which a dielectric layer is sandwiched by a pair of electrode layers and a pair of insulating substrates in order, and detects pressure based on a capacitance value between electrodes which is varied by a deflection amount of at least one of the dielectric layer and the pair of the electrode layers and,

wherein, on each side of the pressure sensor, at least one of the electrode layer and the dielectric layer has concave and convex parts on the surface facing the other layer, and the electrode layer and the dielectric layer are in contact with each other through at least the convex parts of the concave and convex parts.

In the pressure sensor of the present invention, on each side of the pressure sensor, two or more concave parts and two or more convex parts may be provided on the surface of the electrode layer facing the dielectric layer so that the whole surface of the electrode layer has a concave-convex shape, and the electrode layer and the dielectric layer may be in contact with each other through at least the convex parts of the concave and convex parts.

In the pressure sensor of the present invention, two or more concave parts and two or more convex parts may be provided on both surfaces of the dielectric layer so that the whole of both surfaces has a concave-convex shape, and

the electrode layer and the dielectric layer may be in contact with each other through at least the convex parts of the concave and convex parts.

In the pressure sensor of the present invention, on each side of the pressure sensor, the dielectric layer and the electrode layer adjacent to each other may be integrated; the whole of the electrode layer may have a corrugated shape having two or more concave parts and two or more convex parts; and the electrode layer and the dielectric layer may be in contact with each other through at least the convex parts of the concave and convex parts.

### Advantageous Effects of Invention

According to the present invention, at the stage where pressure is relatively low, voids are formed between the electrode layer and the dielectric layer due to the presence of the concave and convex parts, so that pressure can be detected based on the change of the contact area of the electrode layer and the dielectric layer. On the other hand, at the stage where pressure is relatively high, the voids disappear, thereby detecting pressure based on the change of the dielectric layer thickness. Therefore, since the pressure sensor of the present invention has a mode for detecting pressure at a plurality of stages, the pressure sensor can achieve both a large capacitance change mainly at low pressure and miniaturization of a detection part.

### BRIEF DESCRIPTION OF DRAWINGS

FIG. 1 is a view showing a typical example of a pressure sensor of the present invention, and is also a view schematically showing a cross section of the same in its layer stacking direction.

FIG. 2 (a) is a schematic sectional view showing a state in which relatively low pressure is applied to the typical example of the pressure sensor of the present invention along with its layer stacking direction.

FIG. 2 (b) is a schematic sectional view showing a state in which relatively high pressure is applied to the typical example of the pressure sensor of the present invention along with its layer stacking direction.

FIG. 2 (c) is a graph showing the relationship between pressure being applied to a pressure sensor and capacitance change.

FIG. 3 is a schematic sectional view of a first embodiment of the present invention.

FIG. 4 is a schematic sectional view of a second embodiment of the present invention.

FIG. 5 is a schematic sectional view of a third embodiment of the present invention.

### DESCRIPTION OF EMBODIMENTS

The pressure sensor of the present invention comprises a layer constitution in which a dielectric layer is sandwiched by a pair of electrode layers and a pair of insulating substrates in order, and detects pressure based on a capacitance value between electrodes which is varied by a deflection amount of at least one of the dielectric layer and the pair of the electrode layers and,

wherein, on each side of the pressure sensor, at least one of the electrode layer and the dielectric layer has concave and convex parts on the surface facing the other layer, and the electrode layer and the dielectric layer are in contact with each other through at least the convex parts of the concave and convex parts.

In the pressure sensor of the present invention, on each side of the pressure sensor, two or more concave parts and two or more convex parts may be provided on the surface of the electrode layer facing the dielectric layer so that the whole surface of the electrode layer has a concave-convex shape, and

the electrode layer and the dielectric layer may be in contact with each other through at least the convex parts of the concave and convex parts.

In the pressure sensor of the present invention, two or more concave parts and two or more convex parts may be provided on both surfaces of the dielectric layer so that the whole of both surfaces has a concave-convex shape, and

the electrode layer and the dielectric layer may be in contact with each other through at least the convex parts of the concave and convex parts.

In the pressure sensor of the present invention, on each side of the pressure sensor, the dielectric layer and the electrode layer adjacent to each other may be integrated; the whole of the electrode layer may have a corrugated shape having two or more concave parts and two or more convex parts; and the electrode layer and the dielectric layer may be in contact with each other through at least the convex parts of the concave and convex parts.

The inventors of the present invention have found out that, as inventive concept, the following constitution can be achieved without using a plurality of dielectric bodies, the constitution: (1) comprising fine concave and convex parts between an electrode layer and a dielectric layer; (2) by making the concave parts of the fine concave and convex parts be mainly voids, while the constitution being deformed so as to collapse the voids in a low-pressure range, the constitution being deformed by the elasticity of the dielectric layer itself in a high-pressure range. Thus the inventors have achieved the present invention. As described above, by mounting a mode for detecting pressure at a plurality of stages, it is possible to detect pressure in the range from low pressure to high pressure while keeping high resolution in the low-pressure range. Thereby, the capacitance change mainly at low pressure can be made large, and miniaturization of a detection part is possible.

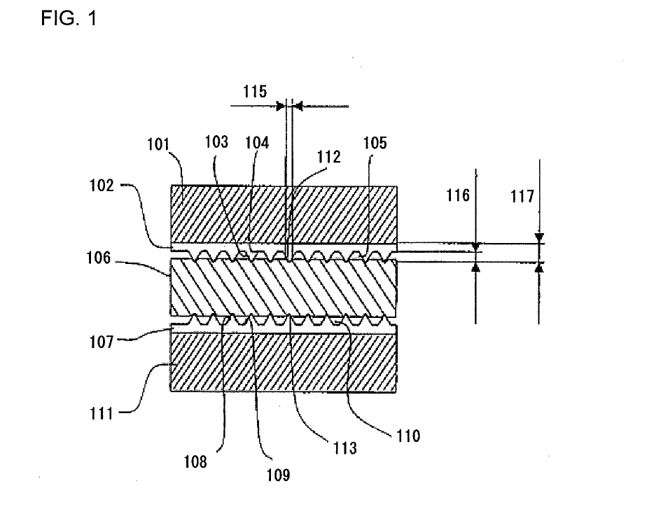

FIG. 1 is a view showing a typical example of a pressure sensor of the present invention, and is also a view schematically showing a cross section of the same in its layer stacking direction.

As shown in FIG. 1, the pressure sensor of the present typical example comprises dielectric layer 106, electrode layers (102, 107) and insulating substrates (101,111), wherein dielectric layer 106 is sandwiched by a pair of electrode layers (102, 107) and the sandwiching body is further sandwiched by a pair of insulating substrates (101,111). On the surface of electrode layer 102 facing dielectric layer 106, a plurality of convex parts 103 and a plurality of concave parts 104 are provided so that the whole surface of electrode layer 102 has a concave-convex shape. Also, on the surface of electrode layer 107 facing dielectric layer 106, a plurality of convex parts 108 and a plurality of concave parts 109 are provided similarly as the surface of electrode layer 102.

In a state in which surface pressure is not applied, dielectric layer 106 and electrode layer 102 are in contact with each other through the vicinity of the edge of each of convex parts 103, and dielectric layer 106 and electrode layer 107 are in contact with each other through the vicinity of the edge of each of convex parts 108. These contact parts (112, 113) and dielectric layer 106 sandwiched by the contact parts form a condenser. The electrode area of the condenser is determined by contact part width 115.

Also, voids 105 are formed between dielectric layer 106 and concave parts 104 of the electrode layer, and voids 110 are formed between dielectric layer 106 and concave parts 109 of the electrode layer. The volume of each of voids (105,110) is determined by the height of concave and convex part 116. The height of concave and convex part 116 is determined by the balance between electrode layer thickness 117 and the thickness of dielectric layer 106.

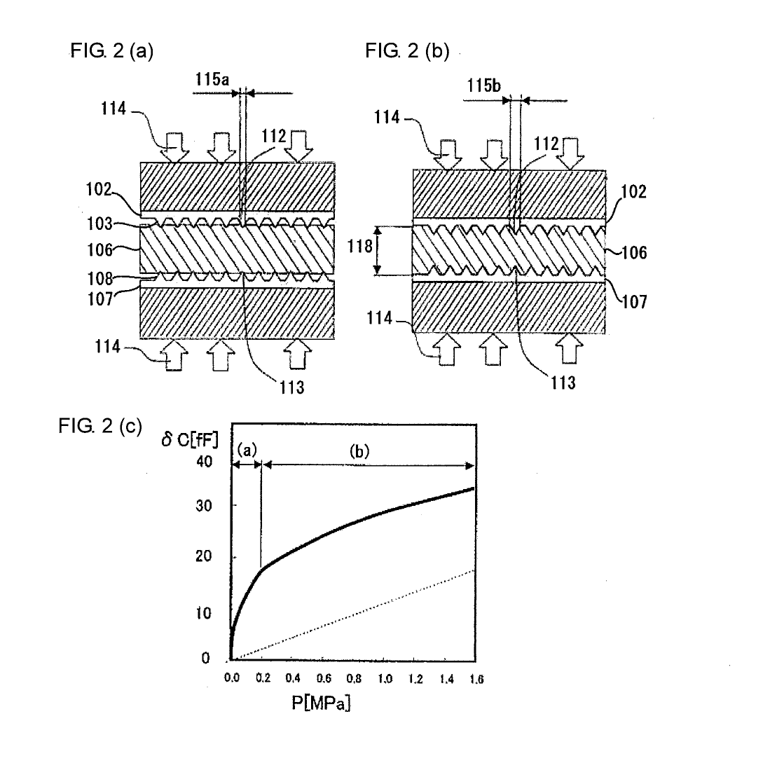

FIG. 2 (a) is a schematic sectional view showing a state in which relatively low pressure is applied to the typical example of the pressure sensor of the present invention along with its layer stacking direction. Arrows 114 in FIG. 2 (a) indicate a direction to which surface pressure is applied.

In the case where pressure is applied along with the layer stacking direction of the stacked body constituting the pressure sensor, when the pressure is relatively low, the constitution largely similar to that shown in FIG. 1 is maintained as shown in FIG. 2 (a). At this time, depending on the magnitude of pressure, convex parts (103,108) of the electrode layers bite into dielectric layer 106 or the height of each of convex parts (103,108) of the electrode layers is decreased, so that contact part width 115a of dielectric layer 106 and electrode layer 102 increases, and contact part width 115a of dielectric layer 106 and electrode layer 107 increases.

As is clear from the following formula (1) representing capacitance of a parallel plate condenser, condenser capacitance C at this time increases with an increase in electrode area S.

C=(∈S)/d Formula (1)

wherein, C represents condenser capacitance, represents permittivity of a dielectric layer, S represents an electrode area, and d represents an electrode interval.

FIG. 2 (b) is a schematic sectional view showing a state in which relatively high pressure is applied to the typical example of the pressure sensor of the present invention along with its layer stacking direction. Arrows 114 in FIG. 2 (b) indicate the same as those in FIG. 2 (a).

In the case where pressure above a certain magnitude is applied along with the layer stacking direction of the stacked body constituting the pressure sensor, the bite of the convex parts of the electrode layer into the dielectric layer and a decrease in the height of the convex parts reach a limit, so that contact part width 115b of dielectric layer 106 and electrode layer 102 sufficiently increases, and contact part width 115b of dielectric layer 106 and electrode layer 107 sufficiently increases, thereby dielectric layer 106 and each of electrode layers (102,107) adhere to each other as shown in FIG. 2 (b). Even if more pressure is applied at this state, contact part width 115b is no longer increased. Instead, dielectric layer thickness 118 decreases. As is clear from the above formula (1), condenser capacitance C increases with a decrease in electrode interval d.

FIG. 2 (c) is a graph showing the relationship between pressure being applied to a pressure sensor and capacitance change. FIG. 2 (c) is also a graph with capacitance change 5C (fF) on the vertical axis and pressure P (MPa) being applied to a pressure sensor on the horizontal axis. In FIG. 2 (c), the pressure range (0 to 0.2 MPa) represented by “(a)” corresponds to the state shown in FIG. 2 (a) described above, and the pressure range (over 0.2 MPa) represented by “(b)” corresponds to the state shown in FIG. 2 (b) described above.

FIG. 2 (c) shows that since capacitance is largely fluctuated by low pressure in pressure range (a), the sensitivity of the capacitance change to pressure is high. The reasons thereof are as follows: (1) with the bite of convex parts (103,108) of the electrode layer into dielectric layer 106 and the decrease in the height of convex parts (103,108) by pressure in the state of FIG. 2 (a), pressure received on the whole electrode layer is concentrated on the edge of the convex parts; and (2) the rate of increase in contact part width 115a due to pressure fluctuation is high.

On the other hand, FIG. 2 (c) shows that an increase in capacitance is relatively gentle in pressure range (b) if pressure is applied. This is because stress is not concentrated in the state of FIG. 2 (b), so that capacitance change δC is determined by elastic modulus of the dielectric layer, thereby capacitance change δC is almost in a linear form in the range that pressure is about 1/100 or less with respect to the elastic modulus of the dielectric layer. As described above, by making the sensitivity of the capacitance change to pressure lower than that in the pressure range (a), it is possible to miniaturize the detection part and the whole device.

The state shown in FIG. 2 (a) is not changed suddenly to the state shown in FIG. 2 (b) by threshold of a certain pressure, and is changed to the state shown in FIG. 2 (b) continuously. Therefore, the graph of capacitance change 5C is a gentle curve as shown in FIG (c).

Hereinafter, a dielectric layer, an electrode layer and an insulating substrate, which constitute the pressure sensor of the present invention, will be specifically explained in order.

The dielectric body used for the dielectric layer is not particularly limited as long as it is an electrical insulation substance generally used for pressure sensors. In the present invention, the dielectric body is preferably a polymer material. Examples of the polymer materials preferably used for the dielectric layer include resins such as polyethylene terephthalate, polyphenylene sulfide, polyethylene, polypropylene, polyimide and Teflon® (product name); elastomer and rubber. Especially, by using a low-modulus material for the dielectric layer, pressure can be detected in a wide range of pressure.

The thickness of the dielectric layer is preferably in the range of 20 nm or more and 40 μm or less depending on the structure of the pressure sensor. Especially in the case of providing concave and convex parts on the electrode layer, the thickness of the dielectric layer is preferably more than twice as thick as the depth of each of the concave and convex parts of the electrode layer from the viewpoint of preventing a short circuit.

The electrode layer is not particularly limited as long as it is a conductive substance generally used for pressure sensors. Examples of the conductive substance used for the electrode layer include metals, carbon-containing resins and conductive resins.

The thickness of the electrode layer is preferably in the range of 5 nm or more and 200 nm or less depending on the structure of the pressure sensor. Especially in the case of providing concave and convex parts on the electrode layer, the thickness of the electrode layer including the height of the convex part on the electrode layer is preferably in the range of 5 nm or more and 200 nm or less. From the viewpoint of increasing the sensitivity in a low-pressure range, the thickness of the electrode layer is preferably reduced as thin as possible so that the electrode layer is likely to bend by pressure.

In the case of providing concave and convex parts on the electrode layer, the shape of the convex parts is preferably a pyramid shape or a conical shape since the shape is easily formed.

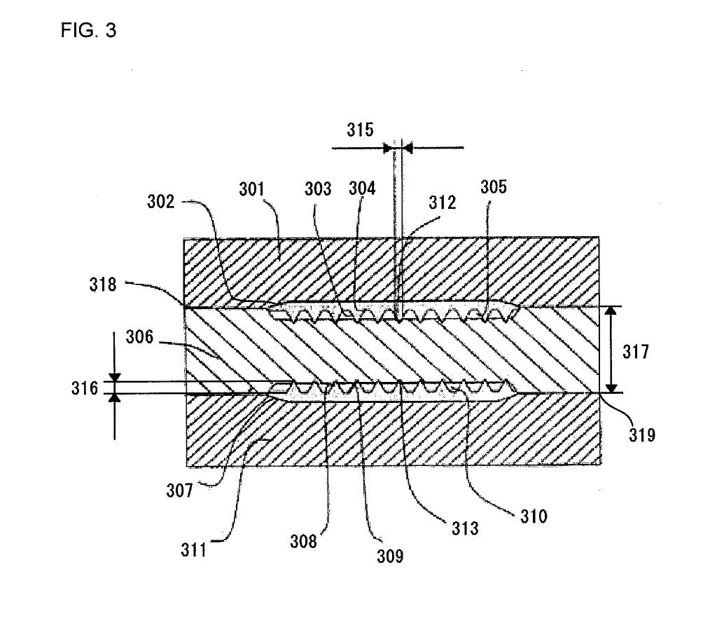

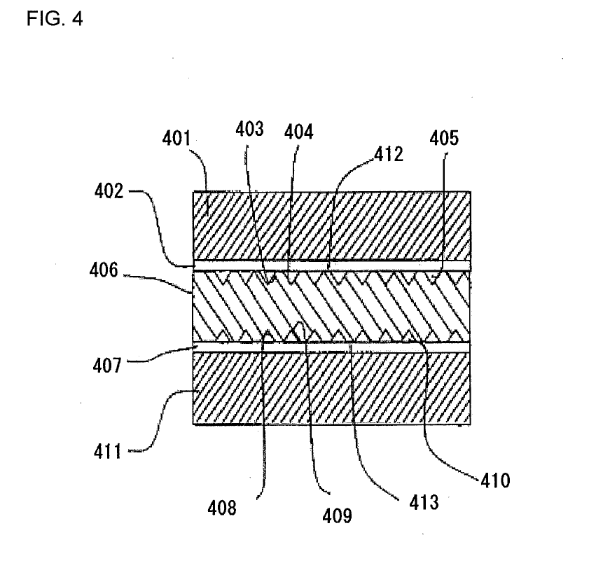

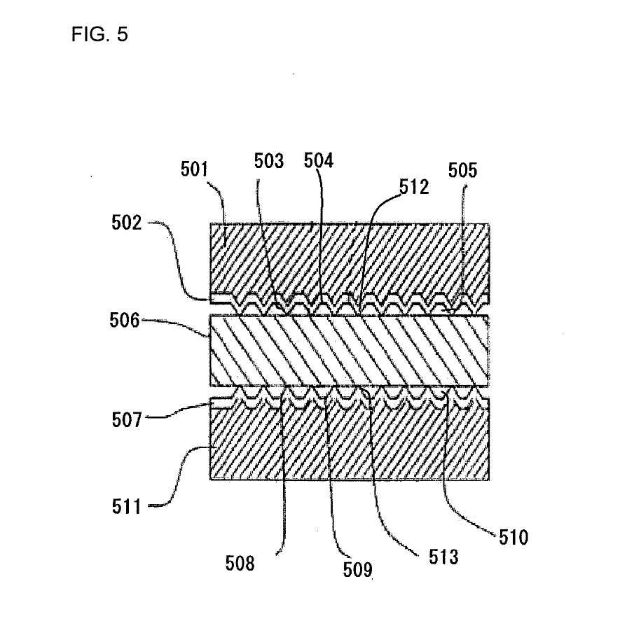

The pressure sensor of the present invention can be constituted so that any concave and convex parts are formed between an electrode layer and a dielectric layer, thereby changing the contact area of the electrode layer and the dielectric layer depending on pressure to be applied. For example, as shown in FIG. 1 described above and FIG. 3 described below, concave and convex parts can be provided on the surface of the electrode layer facing between the electrode layer and the dielectric layer. As shown in FIG. 4 described below, concave and convex parts can be provided on both surfaces of the dielectric layer. As shown in FIG. 5 described below, concave and convex parts can be provided on both surfaces of the dielectric layer and the insulating substrate, which face between the electrode layer and the dielectric layer.

In the initial pressure sensor in which pressure is not applied, it is preferable that voids are formed between the electrode layer and the dielectric layer with at least the concave parts of the concave and convex parts.

From the viewpoint of preventing the fluctuation by air pressure, the voids are preferably in a vacuum state. However, the voids are not limited only to the vacuum state, and can be connected to external air or a basic pressure source. Also, predetermined materials can be filled therein. The permittivity of the predetermined materials is preferably smaller than that of the dielectric body constituting the dielectric layer.

The insulating body used for the insulating substrate is not particularly limited as long as it is an electrical insulation substance generally used for pressure sensors. In the present invention, the insulating body is preferably a polymer material. Examples of the polymer materials preferably used for the insulating substrate include ones described as the materials for the dielectric layer.

The thickness of the dielectric layer is preferably in the range of 2 μm or more and 200 μm or less depending on the structure of the pressure sensor.

Hereinafter, 3 types of the embodiment in the present invention will be explained with reference to figures.

FIG. 3 is a schematic sectional view of a first embodiment of the present invention. As shown in FIG. 3, the first embodiment of the pressure sensor comprises dielectric layer 306, electrode layers (302,307) and insulating substrates (301,311), wherein dielectric layer 306 is sandwiched by a pair of electrode layers (302,307), and the sandwiching body is further sandwiched by a pair of insulating substrates (301,311). The materials and thickness of dielectric layer 306, electrode layers (302,307) and insulating substrates (301,311) are as described above. On the surface of electrode layer 302 facing dielectric layer 306, a plurality of convex parts 303 and a plurality of concave parts 304 are provided so that the whole surface of electrode layer 302 has a concave-convex shape. Also, on the surface of electrode layer 307 facing dielectric layer 306, a plurality of convex parts 308 and a plurality of concave parts 309 are provided similarly as the surface of electrode layer 302.

In a state in which surface pressure is not applied, dielectric layer 306 and electrode layer 302 are in contact with each other through the vicinity of the edge of each of convex parts 303, and dielectric layer 306 and electrode layer 307 are in contact with each other through the vicinity of the edge of each of convex parts 308. These contact parts (312,313) and dielectric layer 306 sandwiched by the contact parts form a condenser. The electrode area of the condenser is determined by contact part width 315.

Also, voids 305 are formed between dielectric layer 306 and concave parts 304 of the electrode layer, and voids 310 are formed between dielectric layer 306 and concave parts 309 of the electrode layer. The volume of each of voids (305,310) is determined by the height of concave and convex part 316. The dielectric layer thickness 317 is more than twice as thick as the height of concave and convex parts 316.

The production example of the first embodiment is as follows. First, electrode layer 302 is formed on one surface of insulating substrate 301, and electrode layer 307 is formed on one surface of insulating substrate 311. Next, dielectric layer 306 is sandwiched by insulating substrates (301, 311) so that the surfaces of insulating substrates (301,311) having electrode layers (302, 307) formed are faced inside. Then, insulating substrate 301 and dielectric layer 306 are bound together through bonded surface 318, and insulating substrate 311 and dielectric layer 306 are bound together through bonded surface 319, thereby obtaining the first embodiment of the pressure sensor of the present invention. Examples of the method for bonding the insulating substrate and the dielectric layer include a bonding with adhesive or hot press especially in the case if at least one of the insulating substrate and the dielectric layer has thermoplasticity.

FIG. 4 is a schematic sectional view of a second embodiment of the present invention. As shown in FIG. 4, the second embodiment of the pressure sensor comprises dielectric layer 406, electrode layers (402,407) and insulating substrates (401,411), wherein dielectric layer 406 is sandwiched by a pair of electrode layers (402,407), and the sandwiching body is further sandwiched by a pair of insulating substrates (401,411). The materials and thickness of dielectric layer 406, electrode layers (402,407) and insulating substrates (401,411) are as described above. On both surfaces of dielectric layer 406, a plurality of convex parts (403,408) and a plurality of concave parts (404,409) are provided so that the whole of both surfaces of dielectric layer 406 has a concave-convex shape.

In a state in which surface pressure is not applied, dielectric layer 406 and electrode layer 402 are in contact with each other through the vicinity of the edge of each of convex parts 403, and dielectric layer 406 and electrode layer 407 are in contact with each other through the vicinity of the edge of each of convex part 408. These contact parts (412,413) and dielectric layer 406 sandwiched by the contact parts form a condenser. The electrode area of the condenser is determined by the contact part width.

Also, voids 405 are formed between dielectric layer 406 and concave parts 404 of the dielectric layer, and voids 410 are formed between dielectric layer 406 and concave parts 409 of the dielectric layer.

The production example of the second embodiment is as follows. First, electrode layer 402 is formed on one surface of insulating substrate 401, and electrode layer 407 is formed on one surface of insulating substrate 411. Next, concave and convex parts are formed on both surfaces of dielectric layer 406. Then, dielectric layer 406 is sandwiched by insulating substrates (401,411) so that the surfaces of insulating substrates (401,411) having electrode layers (402, 407) formed are faced inside, and dielectric layer 406 and each of insulating substrates (401,411) are bound together, thereby obtaining the second embodiment of the pressure sensor of the present invention. The method for bonding the insulating substrate and the dielectric layer is the same as that in the first embodiment described above.

FIG. 5 is a schematic sectional view of a third embodiment of the present invention. As shown in FIG. 5, the third embodiment of the pressure sensor comprises dielectric layer 506, electrode layers (502,507) and insulating substrates (501,511), wherein dielectric layer 506 is sandwiched by a pair of electrode layers (502,507), and the sandwiching body is further sandwiched by a pair of insulating substrates (501,511). The materials and thickness of dielectric layer 506, electrode layers (502,507) and insulating substrates (501,511) are as described above. Insulating substrate 501 and electrode layer 502 are integrated, and insulating substrate 511 and electrode layer 507 are integrated. The whole of electrode layer 502 has a corrugated shape so that the whole surface of electrode layer 502 has a concave-convex shape, and a plurality of convex parts 503 and a plurality of concave parts 504 are provided thereon. Similarly, on the surface of electrode layer 507, a plurality of convex parts 508 and a plurality of concave parts 509 are provided.

In a state in which surface pressure is not applied, dielectric layer 506 and electrode layer 502 are in contact with each other through the vicinity of the edge of each of convex parts 503, and dielectric layer 506 and electrode layer 507 are in contact with each other through the vicinity of the edge of each of convex parts 508. These contact parts (512,513) and dielectric layer 506 sandwiched by the contact parts form a condenser. The electrode area of the condenser is determined by the contact part width.

Also, voids 505 are formed between dielectric layer 506 and concave parts 504 of the dielectric layer, and voids 510 are formed between dielectric layer 506 and concave parts 509 of the dielectric layer.

The production example of the third embodiment is as follows. First, concave and convex parts are formed on one surface of each of insulating substrates (501,511), and electrode layers (502,507) are formed on the surface having the concave and convex parts formed. By making the thickness of each of electrode layers (502,507) thinner than the height of each of the convex parts on the surface having the concave and convex parts formed, the concave-convex shape on the surface having the concave and convex parts formed is transferred to electrode layers (502,507). Next, dielectric layer 506 is sandwiched by insulating substrates (501,511) so that the surfaces of insulating substrates (501,511) having electrode layers (502,507) formed are faced inside, and dielectric layer 506 and each of insulating substrates (501,511) are bound together, thereby obtaining the third embodiment of the pressure sensor of the present invention. The method for bonding the insulating substrate and the dielectric layer is the same as that in the first embodiment described above.

Each of the first to third embodiments has a symmetric structure relative to a dielectric layer. However, at the request of the pressure detection range or the production process, the pressure sensor can be an asymmetric pressure sensor by employing each one side of the structure in each of the first to third embodiments, or applying the production method in each of the first to third embodiments to each one side of the structure.

Also in the first to third embodiments, voids are provided between a dielectric layer and an electrode layer; however, as needed, these voids can be filled with fluid (gas and liquid).

### REFERENCE SIGNS LIST

101,111: Insulating substrate
102,107: Electrode layer
103,108: Convex part of electrode layer
104,109: Concave part of electrode layer
105,110: Void
106: Dielectric layer
112,113: Contact part
114: Arrow indicating direction to which surface pressure is applied
115: Contact part width
115a: Contact part width of electrode layer and dielectric layer in low-pressure range
115b: Contact part width of electrode layer and dielectric layer in high-pressure range
116: Height of concave and convex part
117: Thickness of electrode layer
118: Thickness of dielectric layer
301,311: Insulating substrate
302,307: Electrode layer
303,308: Convex part of electrode layer
304,309: Concave part of electrode layer
305,310: Void
306: Dielectric layer
312,313: Contact part
315: Contact part width
316: Height of concave and convex part
317: Thickness of dielectric layer
318,319: Bonded surface of dielectric layer and insulating substrate
401,411: Insulating substrate
402,407: Electrode layer
403,408: Convex part of dielectric layer
404,409: Concave part of dielectric layer
405,410: Void
406: Dielectric layer
412,413: Contact part
501,511: Insulating substrate
502,507: Electrode layer
503,508: Convex part of electrode layer
504,509: Concave part of electrode layer
505,510: Void
506: Dielectric layer
512,513: Contact part

1. A pressure sensor comprising a layer constitution in which a dielectric layer is sandwiched by a pair of electrode layers and a pair of insulating substrates in order, and detecting pressure based on a capacitance value between electrodes which is varied by a deflection amount of at least one of the dielectric layer and the pair of the electrode layers and,
wherein, on each side of the pressure sensor, at least one of the electrode layer and the dielectric layer has concave and convex parts on the surface facing the other layer, and the electrode layer and the dielectric layer are in contact with each other through at least the convex parts of the concave and convex parts.

2. The pressure sensor according to claim 1,
wherein, on each side of the pressure sensor, two or more concave parts and two or more convex parts are provided on the surface of the electrode layer facing the dielectric layer so that the whole surface of the electrode layer has a concave-convex shape, and
the electrode layer and the dielectric layer are in contact with each other through at least the convex parts of the concave and convex parts.

3. The pressure sensor according to claim 1,
wherein two or more concave parts and two or more convex parts are provided on both surfaces of the dielectric layer so that the whole of both surfaces has a concave-convex shape, and
the electrode layer and the dielectric layer are in contact with each other through at least the convex parts of the concave and convex parts.

4. The pressure sensor according to claim 1,
wherein, on each side of the pressure sensor, the dielectric layer and the electrode layer adjacent to each other are integrated; the whole of the electrode layer has a corrugated shape having two or more concave parts and two or more convex parts; and the electrode layer and the dielectric layer are in contact with each other through at least the convex parts of the concave and convex parts.
